(19) United States
(12) Patent Application Publication
(10) Pub. No.: US 2026/0174071 A1
(43) Pub. Date: Jun. 25, 2026

(54) CASTING DEVICE

(71) Applicant: John Guy Green, Greensboro, GA (US)

(72) Inventor: John Guy Green, Greensboro, GA (US)

(21) Appl. No.: 19/412,356

(22) Filed: Dec. 8, 2025

Related U.S. Application Data
(60) Provisional application No. 63/737,050, filed on Dec. 20, 2024.

(51) Int. Cl. A01K 91/02

(52) U.S. Cl. CPC A01K 91/02

(57) ABSTRACT

A casting device, including a casting portion including a bait cup configured to hold bait thereinside, a spring loaded pump connected to the bait cup wherein the spring loaded pump includes a spring disposed inside the spring loaded pump, such that if the spring is compressed, release of the compressed spring causes the bait disposed within the bait cup to be propelled out of the bait cup based on force applied from the spring to the bait within the bait cup, a slide lever connected to the spring, and a trigger partially disposed on a surface of the casting portion and partially disposed within the casting portion, such that the trigger is connected to the slide lever, and wherein the slide lever is released from a slid-back position to move into a second position in response to the user pressing the trigger, thereby causing release of the compressed spring.

### CROSS-REFERENCE TO RELATED APPLICATIONS

This application claims priority under 35 USC § 120 from U.S. Provisional Application No. 63/737,050, entitled “Casting Device,” which was filed on Dec. 20, 2024, in the United States Patent and Trademark Office, the disclosure of which is incorporated herein in its entirety by reference.

### BACKGROUND

### 1. Field

The present general inventive concept relates generally to a fishing-related device, and particularly, to a casting device.

### 2. Description of the Related Art

Fishing is a recreational activity enjoyed by people of all ages and varying skill sets, yet, often employing traditional casting methods can be challenging, especially for children, novice participants, or individuals with physical limitations.

Currently, casting methods with parabolic trajectories tend to limit an angler's ability to reach certain fishing spots, such as under overhanging trees or in tight spaces along the shoreline, thus limiting a surface area for sourcing a prime catch.

Therefore, there is a need for a fishing and casting device that facilitates casting in all types of environments, configurations, and situations.

There is also a need for a fishing and casting device that propels bait on horizontal plane instead of a traditional device that has a parabolic trajectory.

### SUMMARY

The present general inventive concept provides a casting device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a casting device, including a grip configured to be held by a user, and a casting portion connected to an end of the grip, the casting portion including a bait cup configured to hold bait thereinside, such that the bait cup is disposed at a first end of the casting portion that is farthest away from a second end of the casting portion that is connected to the grip, a spring loaded pump connected to the bait cup wherein the spring loaded pump may include a spring disposed inside the spring loaded pump, such that if the spring is compressed, release of the compressed spring causes the bait disposed within the bait cup to be propelled out of the bait cup based on force applied from the released spring to the bait within the bait cup, a slide lever partially disposed on a surface of the casting portion and partially disposed within the casting portion, such that the slide lever is connected to the spring and such that sliding the slide lever backward causes the spring to compress, and a trigger partially disposed on a surface of the casting portion and partially disposed within the casting portion, such that the trigger is connected to the slide lever, and wherein the slide lever is released from a slid-back position to move into a second position in response to the user pressing the trigger, thereby causing the compressed spring to be released.

The casting device may further include a reel seat disposed between the grip and the casting portion, and a reel attached to the reel seat.

The reel may include a spool assembly configured to be attached to the reel seat and including a fishing line spooled around the spool assembly.

A hook may be attachable to an end of the spool such that the bait is hookable onto the hook, and wherein the baited hook is placed into the bait cup.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a casting device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURE, the thicknesses of lines, layers and/or regions may be exaggerated for clarity.

Accordingly, while example embodiments are capable of various modifications and alternative forms, embodiments thereof are shown by way of example in the FIGURE and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning

commonly understood by one of ordinary skill, this meaning is to be taken into account in the specific context this definition is given herein.

### LIST OF COMPONENTS

Casting Device 100
Grip 110
Casting Portion 120
Bait Cup 121
Spring-Loaded Pump 122
Spring 122a
Slide Lever 123
Trigger 124
Guide Ring 125
Reel Seat 130
Reel 140
Reel Handle 141
Spool Assembly 142
Fishing Line 143

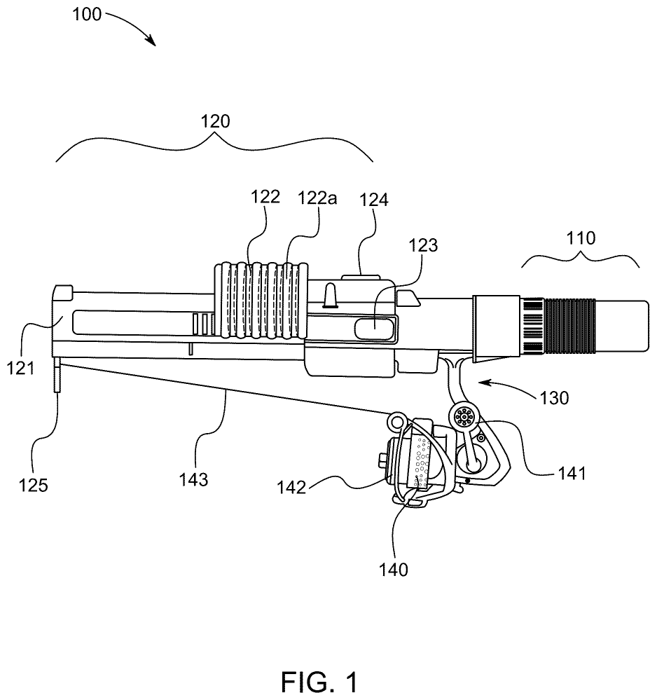

FIG. 1 illustrates a side perspective view of a casting device 100, according to an exemplary embodiment of the present general inventive concept.

Referring to FIG. 1, the casting device 100 may include a grip 110, a casting portion 120, a reel seat 130, and a reel 140, but is not limited thereto.

The casting device 100, and all components therein, may be constructed from at least one of plastic, paper, wood, fiberglass, metal, silicone, liquid, fibers, threads, fishing line, fabric, foam, sponge, feathers, circuitry, glass, and rubber, etc., but is not limited thereto, and can be constructed from any material known to one of ordinary skill in the art.

The grip 110 may be a handle that is holdable by a fisherman (i.e., a person who is fishing), and may be any type of grip known to one of ordinary skill in the art.

The casting portion 120 may include a bait cup 121, a spring-loaded pump 122, a slide lever 123, a trigger 124, and a guide ring 125, but is not limited thereto.

The bait cup 121 may be disposed at a first end of the casting portion 120, opposite from a second end of the casting portion 120 that is closest to the grip 110.

The bait cup 121 may be designed to hold bait, weights, worms, etc. thereinside.

The spring-loaded pump 122 may be connected to the bait cup 121.

The spring-loaded pump 122 may have a spring 122a disposed thereinside. As such, if the spring 122a is compressed within the spring-loaded pump 122 and then released, any objects within the bait cup 121 may be propelled out of (i.e., shot out of) the bait cup 121.

The slide lever 123 may be partially disposed on a surface of the casting portion 120 and partially disposed within the casting portion 120, such that the slide lever 123 is connected to the spring 122a.

The trigger 124 may be partially disposed on a surface of the casting portion 120 and partially disposed within the casting portion 120, such that the trigger 124 is connected to the slide lever 123. As such, if the trigger 124 is pressed, the slide lever 123 may be released from a slid-back position to move into a second position.

In order to compress the spring 122a within the spring-loaded pump 122, a user may slide the slide lever 123 backwards a particular distance. Then, in order to shoot objects out of the bait cup 121, the user may press the trigger 124 to release the slide lever 123, which then releases the spring 122 from its compressed position to an expanded position, which thereby transfers energy and force to objects disposed within the bait cup 121.

It is important to note that the farther back the user slides the slide lever 123, the more the spring 122a is compressed, and the farther objects will shoot out of the bait cup 121 when the spring 122a is released from its compressed position.

The guide ring 125 may be disposed at an end of the casting portion farthest from the grip 110, but is not limited thereto.

The reel seat 130 may be disposed between the grip 110 and the casting portion 120.

The reel seat 130 may be any type of a reel seat known to one of ordinary skill in the art that is designed to easily accept and attach a reel to the casting device 100. As such, the reel 140 may be attached to the reel seat 130.

The reel 140 may be any type of fishing reel known to one of ordinary skill in the art.

The reel 140 may include a reel handle 141, a spool assembly 142, and a fishing line 143, but is not limited thereto.

The reel handle 141 may be wound by a user in order to wind the spool assembly 142, to which the reel handle 141 is attached, in order to wind the fishing line 143, which is at least partially spooled (i.e., disposed) within the spool assembly 142, when a fish is caught, for example.

The fishing line 143 may be threaded through the guide ring 125 in order to allow for the fishing line 143 to be controlled by the user.

In order to perform a fishing operation, the user may place a hook on an end of the fishing line 143, and then bait the hook with a worm and a weight, for example. Then, the user may place the end of the fishing line 143 (along with the hook, worm, and weight) within the bait cup 121. Then the user may slide back the slide lever 123 a predetermined and/or desired distance into a “cocked” position to allow the spring 122a to be compressed a desired amount within the spring-loaded pump 122. Then the user may press the trigger 124 to release the slide lever 123 from its “cocked” position, which causes the spring 122a to release from its compressed position such that the spring 122a either:
(1) hits the bait cup 121; (2) transfers energy and/or force to the bait cup 121, and/or (3) hits the objects disposed within the bait cup 121 such that they shoot out of the bait cum 121.

A main purpose of the present general inventive concept is to introduce a fishing accessory that simplifies bait management and casting abilities for fishermen. Ingenious and practical, the present general inventive concept offers a modern bait casting

accessory that can propel bait along a horizontal path to access otherwise unreachable areas, expanding a fisher's opportunities. Designed to incorporate a pneumatic launcher or spring-loaded launcher, the present general inventive concept allows anglers to control the force delivered and adjust the distance bait travels, enabling a user to target specific areas with greater accuracy, increasing the likelihood of attracting fish. Employing a user-friendly design and adjustable features, this casting device is suitable for anglers of all ages and skill levels, improving the overall fishing experience for everyone involved. The process of utilization requires installing the reel, threading a bail line and then once established securing bait, swivel, and/or weights to the end of the line using a bait cup. At this point the user can rely on the slide mount to adjust the bait launch, noting the closer the mount is to the reel the further a casting distance can be achieved, and then with a draw of a pump which emits a clicking sound to indicate the device is armed, a person can then press the trigger to cause the release. This innovative, top-quality product offers an effective device that helps to mitigate the problem of limited access to fishing locations, imprecise bait placement, and the physical strain often associated with casting routines. As a result, the present general inventive concept may prove to be essential in the sports industry.

The present general inventive concept is the only product of its kind that combines horizontal propulsion, adjustable force, distance control, ease of operation, and targeted bait placement features into a primary casting device that can be used by diverse fishing enthusiasts. This unprecedented product is uniquely designed to serve as a compact valuable tool for anglers seeking to enhance their fishing capabilities and was defined by a proactive fisherman with years of experience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A casting device, comprising:
a grip configured to be held by a user; and
a casting portion connected to an end of the grip, the casting portion comprising:
a bait cup configured to hold bait thereinside, such that the bait cup is disposed at a first end of the casting portion that is farthest away from a second end of the casting portion that is connected to the grip,
a spring loaded pump connected to the bait cup wherein the spring loaded pump comprises a spring disposed inside the spring loaded pump, such that if the spring is compressed, release of the compressed spring causes the bait disposed within the bait cup to be propelled out of the bait cup based on force applied from the released spring to the bait within the bait cup,
a slide lever partially disposed on a surface of the casting portion and partially disposed within the casting portion, such that the slide lever is connected to the spring and such that sliding the slide lever backward causes the spring to compress, and
a trigger partially disposed on a surface of the casting portion and partially disposed within the casting portion, such that the trigger is connected to the slide lever, and wherein the slide lever is released from a slid-back position to move into a second position in response to the user pressing the trigger, thereby causing the compressed spring to be released.

2. The casting device of claim 1, further comprising:
a reel seat disposed between the grip and the casting portion; and
a reel attached to the reel seat.

3. The casting device of claim 2, wherein the reel comprises:
a spool assembly configured to be attached to the reel seat and including a fishing line spooled around the spool assembly.

4. The casting device of claim 3, wherein a hook is attachable to an end of the spool such that the bait is hookable onto the hook, and wherein the baited hook is placed into the bait cup.
